(19) United States
(12) Patent Application Publication
(10) Pub. No.: US 2015/0262254 A1
(43) Pub. Date: Sep. 17, 2015

(54) Digital Exchange Serving as an Integrated, Continuous Sponsorship and Promotion System for Community Businesses, Organizations, and Schools

(71) Applicants: William R. Dunbar, Oconomowoc, WI (US); Matthew D. Serpe, Kenosha, WI (US)

(72) Inventors: William R. Dunbar, Oconomowoc, WI (US); Matthew D. Serpe, Kenosha, WI (US)

(73) Assignee: VIGEOMEDIA, LLC, Kenosha, WI (US)

(21) Appl. No.: 14/656,268

(22) Filed: Mar. 12, 2015

Related U.S. Application Data
(60) Provisional application No. 61/951,574, filed on Mar. 12, 2014.

(51) Int. Cl. G06Q 30/02; G06Q 20/10; G06Q 40/00

(52) U.S. Cl. CPC G06Q 30/0275; G06Q 40/00; G06Q 20/10

(57) ABSTRACT

A method of operating a digital exchange system includes providing a server connected to a communications network, configuring the server to display information on community organizations, individuals and sponsorship needs thereof, displaying electronically-submitted sponsorship offer plans, accepting data regarding the community organizations, individuals, and sponsor. The data is submitted electronically by system users associated with the sponsor, community organizations, or individuals. The method includes registering a participant in one or more sponsorship offer plans. Participation establishes an electronic link in the digital exchange system between the participant, and community organizations or individuals. The method includes providing an electronic revolving sponsorship fund from which funds can be borrowed, electronically allocating the funds to community organizations or individuals, electronically accepting and tracking pledged amounts, to support the revolving sponsorship fund, and providing an electronic credit rating system, which calculates a credit rating used to determine a required aggregate pledge amount.

### CROSS-REFERENCE TO RELATED PATENT APPLICATIONS

This patent application claims the benefit of U.S. Provisional Patent Application No. 61/951,574, filed Mar. 12, 2014, the entire teachings and disclosure of which are incorporated herein by reference thereto.

### FIELD OF THE INVENTION

This invention generally relates to systems and methods for tracking, advising and promoting business and organization activities within a community in a continuous integrated sponsorship marketplace and media network.

### BACKGROUND OF THE INVENTION

In many cases, community organizations, such as youth sports leagues, church groups, and social organizations, rely on sponsorships by local businesses, for example, to fund ongoing operations. Thus, fundraising becomes an important function of the community organization. At the same time these businesses rely on the purchasing power of the organization's members and associates. Thus the digital exchange provides a system and method for sponsorship communications, proposals, acceptance between the businesses, community organizations and complying members and associates with measurable rewards.

To the extent possible, it may be advantageous for community organizations to utilize various media outlets to aid in their fundraising activities. However, for many community organizations, the access cost may be a barrier to certain types of media. Typically, news and information flow to a media outlet via paper transfers, voicemails and telephone conversations, electronically through email systems, electronically through established media interfaces, and/or via field reporters. In most cases, the news and information (data, etc.) input is accomplished manually in the sense that an action must be taken beyond the normal operation of the news event in order to input news to the local media company.

Embodiments of the invention provide a system and method to facilitate sponsorship of community organizations that can be integrated with communications information and news flow networks. These and other advantages of the invention, as well as additional inventive features, will be apparent from the description of the invention provided herein.

### BRIEF SUMMARY OF THE INVENTION

Embodiments of the present invention advantageously address the issues of how organizations can utilize a portion of their sponsorship efforts, for example within a community or region, to cost effectively create visibility for their organization and how businesses can automatically be positioned to receive recognition across an integrated media network in a continuous sponsorship environment.

Embodiments of the present invention a portion of the income flowing from the continuous sponsorship method would be predetermined and automatically set aside to start-up, maintain and expand an integrated community media network. Further, businesses could be rewarded with recognition within the integrated media network they are supporting when their sponsorship reaches a predetermined threshold amount.

In particular embodiments of the present invention, organizations and individuals would be able to communicate and display sponsorship requests for business acceptance through a digital proposal exchange. These businesses would be able to view, accept, or initiate sponsorship proposals directed at specific or any organization or individual registered on the digital proposal exchange.

In one aspect, embodiments of the invention provide a method of electronically facilitating sponsorship of community organizations. The method includes providing a system that includes a networked electronic forum for the submission of a sponsorship proposal, and receiving and processing an electronic communication from a member of a community organization, where the communication indicates acceptance of the sponsorship proposal. The method also includes automatically sending an electronic communication with information regarding the acceptance of the sponsorship proposal by the community organization. Further, the method includes receiving an electronic communication that includes information demonstrating compliance with terms of the sponsorship proposal, and crediting the community organization for each communication demonstrating compliance with terms of the sponsorship proposal.

In a particular embodiment, providing a system that includes a networked electronic forum for the submission of a sponsorship proposal comprises providing a system that includes a networked electronic forum for the submission of a sponsorship proposal and for the registration of the community organization.

In a further embodiment, electronic communications are sent and received via the internet. More particular embodiments of the method include configuring the system to send and receive electronic communications via a mobile communications device. The mobile communications device may be a tablet computer or a smart phone.

Certain embodiments of the method include maintaining a database that stores contact information of members and associates of the community organization. The method may also include automatically sending electronic communications to members and associates of the community organization regarding the acceptance of the sponsorship proposal by the community organization, where the electronic communications further specify terms of compliance for the sponsorship proposal. Further, the method may include configuring the system to allow members and associates to send electronic communications to third parties regarding the acceptance of the sponsorship proposal by the community organization.

In a particular embodiment of the invention, the method further includes generating an identification code, where the identification could be either a matrix barcode, a barcode, or an identification number. In more particular embodiments, receiving electronic communications that have information demonstrating compliance with terms of the sponsorship proposal includes receiving electronic communications with the identification code number. Further, the identification code may be uploaded to the digital exchange by the sponsor.

In certain embodiments, crediting the community organization for each communication demonstrating compliance with terms of the sponsorship proposal comprises awarding a number of points (or alternatively a percentage of purchase sale or a fixed amount per purchase) to the community organization for each communication demonstrating compliance with terms of the sponsorship proposal, where each point awarded has a monetary value.

The method may further include receiving data about a community event, transforming the data into a format for viewing at one or more locations in the community, and transforming a portion of the data into print-ready verbiage. Particular embodiments may include parsing the data to obtain information regarding the community event, selecting at least one text option to use to display the information, adding the information to the at least one text option to create a part of the print-ready verbiage, and combining the part of the print-ready verbiage to other parts of the print-ready verbiage to form the print-ready verbiage. Even more particular embodiments may include automatically generating an entry in an electronic community-based media communication when the community organization is credited a predetermined threshold amount by the server.

In another aspect, embodiments of the invention provide a system for facilitating sponsorship of community organizations. The system includes a computer server connected to a communications network. The communications network may be the internet or an intranet. The server is programmed to accept and process a registration submitted over the network by a community organization, to accept and process a sponsorship proposal submitted over the network by a sponsor, and to receive communications indicating acceptance of the sponsorship proposal by the community organization. The server is also programmed to automatically send communications regarding acceptance of the sponsorship proposal to members of the community organization, to receive communications demonstrating compliance with terms of the sponsorship proposal; and to credit the community organization for each communication received demonstrating compliance with terms of the sponsorship proposal.

In a particular embodiment, the server is programmed to generate an identification code for a user of the digital exchange. The aforementioned communications demonstrating compliance with terms of the sponsorship proposal may include the identification code. Further, the server may be programmed to distribute the identification code to a mobile communications device.

In certain embodiments, the server includes a database with contact information for members of the community organization, and may include contact information for associates or affiliates of the community organization. Also, the server can be programmed such that system users can arrange to automatically send electronic communications to third parties regarding acceptance of the sponsorship proposal to members of the community organization.

In further embodiments, the credit provided the community organization for each communication received demonstrating compliance with terms of the sponsorship proposal is accomplished by awarding some number of points to the community organization, wherein each point has a monetary value (or alternatively awarding a percentage of sale or a fixed amount of money for each sale).

In yet another aspect, embodiments of the invention provide a method to facilitate sponsorship proposals between community organizations and sponsors. The method includes integrating a digital media center, a sponsorship exchange system, and an Advise System that includes Needs Plans of community organizations and Objectives Plans of sponsors, and connecting businesses with organizations and residents within a community to facilitate sponsorship of individuals and organizations that are linked to advised promotions across the digital media network. The method further allows receiving information from a point-of-sale (POS) system operated by the sponsor, and allocating funds to community organizations based on the information received from the POS system and information previously input from the registered user.

In a certain embodiment, the method includes electronically receiving information from a point-of-sale (POS) system, either manually by operators or automatically, at specified time intervals. In some embodiments, receiving information from a point-of-sale (POS) system includes receiving customer identification information from a point-of-sale (POS) system. Further, this allocation of funds to community organizations may be accomplished without any additional input from the customer. In some instances, the allocation of funds to community organizations is based on previously-made default selections by the customer.

In yet another aspect, embodiments of the invention provide a method to facilitate sponsorship proposals between community organizations and sponsors. The method includes integrating a digital media center, a sponsorship exchange system, and an Advise System that includes Needs Plans of community organizations and Objectives Plans of sponsors, and connecting businesses with organizations and residents within a community to facilitate sponsorship of individuals and organizations that are linked to advised promotions across the digital media network. The method further allows receiving information from a mobile communications device via a mobile application used by the sponsor, and allocating funds to community organizations based on the information received from the mobile communications device and information previously input from the registered user.

In a particular embodiment, a method for an organization, school or program administrator to request registration of individuals for participation in a given sponsorship or fundraising program or to become a subscriber of a media platform associated with a given organization, school or program, thereby connecting individuals to specific fundraising needs of that program and media platforms associated with that organization, school or program, and including the individuals who accept into the group or network of people that have a common goal of attaining the sponsorship or fundraising goals and/or supporting a specific media platform.

Embodiments of the invention include a method for individuals that are participating in the sponsorship exchange system to periodically pledge amounts of purchase or sponsorship activity. For example, a typical pledge amount may be $10 per month, and the sponsorship activity may consist of specific needs at different levels relative to specific organizations, schools or programs. The method may include, for example, selecting projected purchases on a monthly basis from a list of consumer items (e.g., restaurant food, gasoline, groceries, etc.). The system then calculates potential sponsorship amounts based on those projected purchases. Another method may be to simply pledge an amount and the system then delivers possible purchase behavior and places of business to make those purchases to attain that pledged amount. The user is then notified continuously of opportunities to purchase with specific sponsorship deals based on data input into the pledge notification system. The pledges can be for needs at different levels and can be for school needs, program needs, community organization needs, tuition assistance programs for individuals, or fee reduction programs for individuals.

A method for an organization, school, program or individual to periodically receive reports relative to sponsorship and media platform subscriptions. These reports detail the results of the individual and collectively the group compared to goals and/or averages of the group. These reports include sponsorship amounts, number of subscribers, number of readers, and other relevant data of the group.

A method for organization/program members to petition/request/suggest other individuals to participate in a specific sponsorship initiative, can be for a single event or continuously.

A method to target individuals that participate in a sponsorship and/or digital/electronic network where purchase offers, prizes, and/or other marketing information are presented through a code that can be scanned/read via a mobile device app (e.g., a matrix barcode being scanned by an app on a smart phone or computer tablet). After scanning the matrix barcode, the user is sent to a site where a business deal is presented to the user that is unique to that user. The uniqueness of the deal is determined by an algorithm or set of algorithms within the system, based on the activity of the user in the system and/or information input by the user into the system. The user is identified by the system via the unique user registration information, such as user ID, password, cell phone number, exchange/network ID number, etc. The deal can be for a purchase that includes a discount, a purchase that includes a sponsorship for one or more schools, organizations or programs within, a gift card or prize, a purchase that includes a raffle ticket for determined prizes, or a combination thereof. The code can be displayed on any media platform, digital or otherwise, for example, within a newspaper, magazine, website, digital magazine, email, poster bulletin, newsletter, etc. “Reward points” are earned as the user uses the system—for example, a certain amount of points is earned for scanned offers that are declined and scanned offers that are accepted.

In a further embodiment, the method for businesses to target specific customer sets based on organization/school memberships or participation, or based on sponsor exchange purchase activity. For example, businesses may target network users that are currently not their customers (where the definition of current customer is provided by the business—e.g., a cardholder/participant may be a current customer of a business if he/she has made a purchase in the last three months). Businesses may target customers that will agree to make purchases at non-peak hours or seasons. Alternatively, businesses may target participants of certain organizations, schools, or programs.

In a particular embodiment of the invention, a method for automatically tracking when business matrix barcode scan costs reach a predetermined threshold amount, thereby generating an entry into a dataset linked to a content/advertisement management system to ultimately position an advertisement for a business in one or more of the media platforms in a geographically determined area. Businesses will pay a specified amount for each matrix barcode scan. Businesses will pay a specified amount for a scan that does not result in a purchase. Businesses will pay another specified amount for a scan that does result in a purchase. These scan amounts will be tracked and once the amount reaches a predetermined level of amount, an advertising space is allotted to that business on a determined media platform. For example, the matrix barcodes may be placed in a daily print newspaper. Once the scan charges reach a certain level, the business will be notified that a certain amount of advertising inventory is available for that business to run/display an ad at no additional or lower charges.

In certain aspects, a method to offer a sponsorship system for tuition assistance or contributions to college savings plans whereby the user participates in an educational question/answer process and a winner is selected from those that answer the set of one or more questions correctly. The user scans or reads a code via a mobile device (e.g., a matrix barcode being scanned by an app on a smart phone or computer tablet). The code can be displayed on any media platform, digital or otherwise, for example, within a newspaper, magazine, website, digital magazine, email, poster bulletin, window cling, newsletter, etc. After the code is scanned, the user is sent to a site where information is provided via a set of slides, or thru a video, or thru photos with captions, or thru articles. This code can be a companion to other media content, such as a companion to an article in a newspaper, where the information in the code educational system is relevant to the article in the newspaper. The user is identified by the system via the unique user registration information, such as user ID, password, cell phone number, exchange/network ID number, etc. After the information is presented, the user answers a set of one or more questions. Depending on the answers, the user may be positioned for a drawing for a “prize”—such as an amount of money towards a college savings plan or tuition reimbursement.

The aforementioned method for exchange/network users linked to a given organization, school and/or program to petition others in the network, whether or not they are directly connected to the petitioning school, organization or program, to participate in a specific sponsorship program or event (e.g., a 20% giveback sponsorship for a given Tuesday at a specified restaurant for a specific program within a school—please join in our sponsorship event). The system would provide an ID card for those that accept and are not currently linked to the petitioning school, organization or program.

A method where an individual network/exchange participant may propose a sponsorship event or program for a participating school, organization or program of the exchange/network, and invite other participants of the network/exchange to participate in the event or program, whether or not they are directly connected to the sponsored school, organization or program. The proposer creates a proposal with one of the participating businesses and sends the proposal to that business. The business then either accepts or denies or counters with another proposal. Once a proposal is accepted by both the individual and the business, then the system is prepared to have individual exchange/network participants attach to this proposal for compliance.

In certain embodiments, the aforementioned method wherein a matrix barcode is placed in/on a media platform (e.g., a newspaper, magazine, digital magazine, website, etc.). The matrix barcode is scanned with a digital app that sends the user to a digital application platform where the user can then log in and begin the process of proposing a sponsorship event.

In one aspect, a method where the extent of exchange activity provides reward points for media coverage for schools, organizations, and programs. The system tracks the activity in the digital marketing network and “media coverage points” are earned each time activity such as purchases are made or matrix barcodes are scanned. Once a specified level of media coverage points are earned, a notification is sent to the relevant school, organization, team or program and the appropriate media coverage is established and executed. Points may be earned for media coverage—where a certain amount of points will earn coverage of an event of the organization, school, or program within. Media coverage means that efforts will be put forth to cover an event and publish an article or video or photos of the event.

In another aspect, a method where a matrix barcode system in/on a given media platform (e.g., a newspaper, magazine, digital magazine, website, etc.) serves as a service directory that is attached to a digital marketing network for a given region, that displays purchase deals for services/products that offer sponsorships for community organizations, schools and programs. The deals can also offer discounts, gift cards, reward points, raffle tickets for an upcoming raffle event.

In another aspect, wherein sponsorship and marketing deals are offered for both discounts and sponsorship (possibly including raffles)—wherein reward points are earned for exchange participants (ID cardholders) that provide referrals for the businesses in the directory. These referrals would be viewed by participants that are connected in a “referral network.”

A method, further comprising providing, via matrix barcode usage, reward points to reduce subscription prices of media platforms, wherein the system tracks matrix barcode scan activity by the user, and provides an option for the media platform provider employing the matrix barcodes to offer a subscription price reduction or credit based on the amount of activity of a given user.

A method where a school, organization or program director can request/suggest a pledge arrangement/system be used to attain financial needs in the digital network.

In yet another aspect of the invention, the individual that is making the proposal and having the proposal exchange with the participating business is electronically awarded a reward, such as a gift card or loyalty points or a discount, etc., from that business in return once the proposal is accepted by both parties and becomes a sponsorship plan. Once awarded, the individual makes a purchase at that business and the award will be attached to the individual's account and visible to the business, and awarded at that time. In a particular embodiment, a matrix barcode is displayed throughout the community (e.g., on a poster advertisement at a table in a restaurant) that when scanned sends the person who scans the code to a site where information and data can be submitted for possible use in a media center/network—a number of media platforms (digital, print, etc.)—and reward points or awards are earned as a result of the content submittal—the awards can be any combination of sponsorship funds for community organizations, discounts at participating businesses, gift cards, event tickets, etc. Also, advertisement credits may be earned by the sponsor as described in certain embodiments of the invention.

A revolving sponsorship fund (RSF) may be established to allow funds to be developed, consumed, and replenished by the community organizations or the programs within. The RSF is an account where community organizations (or programs within the community organization) can at times borrow an amount of money as needed—like a line of credit. The RSF may be established by one or more individuals or entities via donation and/or through purchase activity in the digital exchange system. Further, a pledge system may be utilized to establish the support group for the community organization (or program within the community organization) to borrow from the RSF—i.e., a group of people are registered in the digital exchange system, linked to a particular community organization or program within (e.g., a specific team in a sports organization or the drama club or a sports program within a school)—the registered users linked then pledge amounts of sponsorship through participation in the digital exchange system (like $10/month for a year, etc.)—the pledge amounts are tallied—when the collective (aggregate) pledge amount reaches a predetermined sponsorship level over a specified period, the RSF $ (like a line of credit) become available for the organization or program and the group then participates in the digital exchange system with the objective of achieving the sponsorship amount as pledged. A refundable deposit is provided rather than a donation. The refundable deposit, like a donation, can be directed at the RSF or directly to a community organization or program within the community organization through the compartmentalized sponsorship fund. In certain embodiments, where an interest rate is attached to the refundable deposit.

In certain embodiments, the sponsorship proposal includes a “pay-per-pledge” term—where a sponsorship proposal exchange is occurring between a community organization, or a program within a community organization, with a sponsor. The community organization participants collectively pledge to purchase an amount, thereby yielding an amount of sponsorship. The “pay-per-pledge” term in the proposal, and once the proposal is accepted becoming the sponsorship plan, would be where a sponsor pays a portion or all of the pledged sponsorship amount up front before the purchases take place.

In particular embodiments, a refundable deposit is provided rather than a donation. The refundable deposit, like a donation, can be directed at the RSF or directly to a community organization or program within the community organization through the compartmentalized sponsorship fund. An interest rate may be attached to the refundable deposit.

Embodiments of the invention include a method where sponsors such as corporations, other businesses or organizations, or individuals can electronically pledge matching sponsorships—this matching sponsorship function being integrated with the digital exchange system. Corporate and individual matching sponsorships represent the system capability to electronically input or accept these matching sponsorship offers. Once a matching sponsorship offer is pledged electronically in the system, and as individuals then make purchases in the digital sponsorship exchange system, a matching sponsorship amount is also gained by an organization or program within as defined by the matching sponsorship offer (e.g., a $0.50 match for every sponsorship $1 earned). The system is configured to track the purchase activity and automatically account for the matching amounts.

Embodiments of the invention include a system and method in which a revolving sponsorship fund (RSF) is established and integrated with a digital sponsorship exchange system. The RSF serves to allow funds to be borrowed, with or without interest, and replenished by the community organizations (including schools) and the programs within those organizations via participation in the digital sponsorship exchange system. Community organizations and/or the programs within those organizations use the funds available in the compartmentalized sponsorship fund for their organizational needs—operating and/or capital. Individuals and businesses participate in the digital sponsorship exchange system and funds are generated for organizations and/or programs within those organizations. Funds may be temporarily held in the compartmentalized sponsorship fund for the various organizations and programs.

The method may also include a pledge system to establish the support group for the community organization or program within the organization to borrow from the revolving sponsorship fund (RSF). For example, a group of people and/or entities may be registered in the digital sponsorship exchange system, and linked to a particular community organization and/or program within that particular organization (e.g., a specific team in a sports organization or the drama club or a sports team within a school)—the registered users pledge amounts of sponsorship through participation in the digital sponsorship exchange system (e.g., $10/month for a year). The pledge amounts are tallied and when the collective (aggregate) pledge amounts for the entire group reaches an acceptable sponsorship pledge level, the RSF funds, similar to a line of credit, become available for the organization or program and the group. The transactions are facilitated by the digital sponsorship exchange system with the objective of achieving the sponsorship amount as pledged, plus any interest that has accrued (if applicable) until the borrowed amount is paid in full.

The method may also include a credit rating system that depends on variables such as (1) amount of registered users/cardholders activity in the digital sponsorship exchange system for those registered users linked to the organization or program within that are requesting funds from the RSF, (2) the pledge and participation history of the linked, registered users/cardholders—relative to both amount currently pledged in the system by each registered user and to how well each registered user has done historically with previous pledges, and (3) the pledge history of the organization or program relative to repayment of borrowed funds. An algorithm in the digital sponsorship exchange system calculates a credit rating based, in part, on the variables above. Credit rating scores directly impact the aggregate pledge amount necessary to be approved for the requested funds from the RSF. For example, an organization requests to borrow $10,000. A relatively high credit rating for a linked group of people may require a pledge amount totaling to $12,000 over a specified period of time. A relatively low credit rating for a linked group of people may require a pledge amount totaling to $14,000 over a specified period of time. Credit ratings may also impact interest rates, if applicable.

The digital sponsorship exchange system may be constructed to track the actual sponsorship amounts produced and compares those actual amounts to the pledge amounts for each registered user and aggregately for the organization or program within the organization. Notifications may be electronically sent to linked, registered users and to administrators of organizations or programs—to notify each recipient of their individual performance of actual sponsorship relative to pledged amounts—and to also notify all recipients of the performance of the group collectively, actual sponsorship earned relative to the amount pledged. In certain embodiments, the system provides the means, such as an electronic interface, for an individual registered user or entity to electronically co-sign for the borrowed funds—meaning that the cosigner accepts responsibility for repayment of the borrowed funds, including any accrued interest if applicable.

Embodiments of the invention include a method where a “digital scratch-off app” (e.g., displayed on a user device at business locations throughout a community) displays a “scratch-off mystery offer, reward or prize.” When prompted to do so (e.g., clicking a button or touching a button on a touch-screen display), the app displays the removal of the “scratch-off covering” to reveal a result—can be a mystery offer, reward, gift card, or other prize. The “digital scratch-off app” may also be linked to a digital network (sponsorship and/or marketing network). The app displays a “scratch-off mystery offer, reward or prize.” For example, the user presents an ID code also linked to the digital network (sponsorship and/or marketing network)—the code is input into the app (manually or by scanning a barcode or other scannable code on an ID card—digital or not)—the app then displays the removal of the “scratch-off covering” to reveal a result—can be a mystery offer, reward, gift card, or other prize.

A cash-back rewards system may be combined with a digital exchange and sponsorship network. The cash-back reward system provides a means for participants to receive cash-back rewards that can be used to pay individual fees, school tuition, etc. to participating organizations and schools. The cash-back rewards system may also be linked to the revolving sponsorship fund (RSF). Individuals can then borrow from the revolving fund to pay for fees, tuition, etc.—and then participate in the exchange network to pay down/back the borrowed funds, plus any interest incurred if applicable. A pledge system can be used to establish the support group for the individual to borrow funds for the cash-back rewards system. A credit rating system may be established for the revolving fund and linked to the cash-back rewards system. Furthermore, a digital marketing or sponsorship system may be used to allow entities (businesses, etc.) to position themselves into a pledge system where potential customers can pledge to do business with a given entity.

In still another aspect, embodiments of the invention provide a method to facilitate sponsorship proposals between organizations and sponsors. The method includes integrating a digital media center network, a sponsorship exchange network system, and an advise system having a database and configured to continuously electronically monitor purchasing behavior and to maintain, within the database, statistical calculations of purchase behavior. The advise system is further configured to use the statistical calculations to automatically generate a sponsorship proposal that matches an individual organization with an individual sponsor, based on particular funding needs of the individual organization and on particular objectives of the individual sponsor.

In a further embodiment, the method includes the step of configuring the advise system to automatically transmit a targeted promotion to one or more groups or individuals, wherein the targeted promotion is based on the sponsorship proposal. The method may also include the step of transmitting the targeted promotion to the one or more groups or individuals via electronic mail or electronic text message. In yet another embodiment, the method calls for configuring the advise system to monitor amounts pledged by the one or more groups or individuals in accordance with terms of the sponsorship proposal, and determine possible purchase behavior and places of business to make purchases that will allow the one or more groups or individuals to attain a pledged amount. In a more particular embodiment, the method requires configuring the advise system to automatically notify the one or more groups or individuals of new promotions implemented in support of the sponsorship proposal, when the advise system determines that the new promotion is of interest to the one or more groups or individuals.

In certain embodiments, the method includes the step of configuring the advise system to automatically transmit the targeted promotion over the digital media center network, wherein the targeted promotion is based on the sponsorship proposal. The method may further include the step of configuring the advise system to evaluate the particular funding needs of the individual organization, the funding needs being in the form of a needs plan, which can accommodate one or more needs having different priorities, and wherein the advise system takes these priorities into account when generating the sponsorship proposal. The needs plan may include needs having different priorities and different funding requirements. In a particular embodiment, the method calls for registering one or more groups or individuals participating in the sponsorship proposal, and linking, within the advise system, each registration with at least one of the one or more needs in the needs plan.

In certain embodiments, the method includes the step of configuring the advise system to generate a sponsorship profile for each sponsor, the sponsorship profile including all of the sponsorship proposals accepted by the respective sponsor along with a status thereof. In a further embodiments, the method includes the step of configuring the advise system to distribute targeted promotions to the one or more groups or individuals participating in the sponsorship proposal by distributing a matrix barcode that can be scanned via a mobile electronic device, wherein scanning the matrix barcode, transfers a mobile electronic device user to an electronic site where the user can participate in transactions that support objectives of the sponsor. In some embodiments, the method calls for configuring the advise system to display the matrix barcode on the digital media center network, and crediting the user for viewing the targeted promotion. In other embodiments, the method includes the step of configuring the advise system to credit, each time a matrix barcode is scanned, the sponsor associated with the scan. In a further embodiment, the method requires configuring the advise system to crediting the user for submission of information for distribution on the digital media center network.

In a particular embodiment, the method includes the step of configuring the advise system to provide an electronic pledge feature devised to allow the sponsor to tailor a specific customized promotion for an individual or group within the sponsorship exchange system. The electronic pledge feature may be further devised to allow sponsors to compete against one another via an electronic bidding pricing system for improving their respective customized promotions. The method may also include the step of configuring the advise system to evaluate the particular objectives of the individual sponsor, the objectives being in the form of an objectives plan, which can accommodate one or more objectives having different priorities, and wherein the advise system takes these priorities into account when generating the sponsorship proposal. The objectives plan may include objectives having different priorities and different funding levels. The method may further include the step of accepting a pledge from the one or more groups or individuals that links, within the advise system, the pledge with at least one of the one or more objectives in the objectives plan.

In still another aspect, embodiments of the invention provide a method of operating a digital exchange system. The method includes providing a server connected to a communications network configured for two-way communications with system users configuring the server to display, on a system-user device, information on one or more community organizations or individuals and sponsorship needs thereof, accepting, and displaying on the system-user device, electronically-submitted sponsorship offer plans from a sponsor for one or more community organizations or individuals, accepting data regarding the one or more community organizations or individuals and the sponsor, the data submitted electronically by system users associated with the sponsor or the one or more community organizations or individuals, and registering a participant desiring to participate in one or more sponsorship offer plans, wherein said participation establishes an electronic link in the digital exchange system between the participant and the one or more community organizations or individuals. The method further includes providing an electronic revolving sponsorship fund, wherein the one or more community organizations or individuals can borrow funds from the revolving sponsorship fund, electronically allocating the borrowed funds to the one or more community organizations or individuals, based on an amount requested by the one or more community organizations or individuals, and based on available funds in the revolving sponsorship fund, electronically accepting and tracking pledged amounts, from digital exchange system users, to provide support for borrowing funds from the revolving sponsorship fund, and providing an electronic credit rating system, which calculates a credit rating that is used to determine a required aggregate pledge amount necessary for approval and allocation of the requested amounts to one or more community organizations or individuals.

In some embodiments, the credit rating system calculates the credit rating based on an activity history in the digital exchange system of the registered participants associated with the organization requesting the funds. In other embodiments, the credit rating system calculates the credit rating based on a pledge history of the registered participants associated with the organization requesting the funds. The credit rating system may also calculate the credit rating based on a pledge history of the community organization that is requesting the funds. Also, the credit rating system may provide the means for an individual registered user of the digital exchange system to electronically co-sign for the borrowed funds from the revolving sponsorship fund.

In still other aspects, embodiments of the invention provide a method of operating a digital exchange system. The method includes providing a server connected to a communications network configured for two-way communications for system users, registering a participant or user desiring to participate in a community marketing network, and requiring the user to provide unique identification information, configuring the server to display offers, prizes, or other marketing information on system user devices, accepting electronically-submitted offers, identifying the user via unique user registration information; and linking a digital application function to the user, the digital application function being operable remotely via a unique location or identification, wherein the digital application function displays offers, rewards or prizes, which are unique to the user.

The server may be configured to display offers, prizes, or other marketing information comprises configuring the server to display offers, prizes, or other marketing information based on industry category. Also, the method includes configuring the server to display, on a system user device, information on one or more community organizations or individuals and sponsorship needs thereof, accepting, and displaying on the system-user device, electronically-submitted sponsorship offer plans from a sponsor for one or more community organizations or individuals, accepting data regarding the one or more community organizations or individuals and the sponsor, the data submitted electronically by system users associated with the sponsor or the one or more community organizations or individuals, and registering a participant desiring to participate in one or more sponsorship offer plans, wherein said participation establishes an electronic link in the digital exchange system between the participant and the one or more community organizations or individuals.

In certain embodiments, the digital application function is performed by a “digital scratch-off application”, which displays a digitally removable “scratch-off covering” which, when removed, reveals one or more of the offers, rewards or prizes, and the “digital scratch-off application” is linkable to a digital network and accessible to the participant or user via a coded input such that, upon receipt of the coded input, the scratch off covering is removed.

In some embodiments, the method calls for providing an advise system having a database and configured to continuously electronically monitor purchasing behavior and to maintain, within the database, statistical calculations of purchase behavior, wherein the advise system is further configured to use the statistical calculations to automatically generate a sponsorship proposal that matches an individual organization with an individual sponsor, based on particular funding needs of the individual organization and on particular objectives of the individual sponsor. The method may also include the step of configuring the advise system to monitor amounts pledged by one or more groups or individuals in accordance with terms of the sponsorship proposal, determine possible purchase behavior and places of business to make purchases that will allow the one or more groups or individuals to attain a pledged amount, and automatically notifying the one or more groups or individuals of new promotions implemented in support of the sponsorship proposal, when the advise system determines that the new promotion is of interest to the one or more groups or individuals. The method may further include the step of configuring the advise system to automatically transmit a targeted promotion to one or more groups or individuals, wherein the targeted promotion is based on the sponsorship proposal, wherein the targeted promotion is transmitted to the one or more groups or individuals over a digital media network, or via electronic mail, or via electronic text message.

In a particular embodiment, the method requires the step of configuring the advise system to generate a sponsorship profile for each sponsor, the sponsorship profile including all of the sponsorship proposals accepted by the respective sponsor along with a status thereof. In other embodiments, the method includes the step of configuring the advise system to provide an electronic pledge feature devised to allow the sponsor to tailor a specific customized promotion for an individual or group within the sponsorship exchange system, the electronic pledge feature being configured allow sponsors to compete against one another via an electronic bidding pricing system for improving their respective customized promotions.

Further, in other aspects, embodiments of the invention provide a method of operating a digital exchange system. The method includes providing a server connected to a communications network configured for two-way communications with system users, configuring the server to display, on a system-user device, information on one or more community organizations or individuals and sponsorship needs thereof, accepting, and displaying on the system-user device, electronically-submitted sponsorship offer plans from a sponsor for one or more community organizations or individuals, accepting data regarding the one or more community organizations or individuals and the sponsor, the data submitted electronically by system users associated with the sponsor or the one or more community organizations or individuals, registering a participant desiring to participate in one or more sponsorship offer plans, wherein said participation establishes an electronic link in the digital exchange system between the participant and the one or more community organizations or individuals, tracking an extent of participation in the sponsorship offer plan by the participant, allocating proceeds to the one or more community organizations or individuals based on the extent of participation in the sponsorship offer plan by the participant, and electronically allocating proceeds to a cash-back savings account for the participant.

The method may include allocating payment of fees to community organizations from the cash-back savings account of the participant. The method may also call for providing an electronic revolving fund where participants can request to borrow funds to pay fees to community organizations. Additionally, the method may include configuring an electronic pledge system wherein participants can pledge to do business with sponsors for specified offers. The method may call for configuring the electronic pledge system to establish a support network for the participant. In some embodiments, the method requires providing a credit rating system that calculates a credit rating for the support network to determine a pledge amount required in order to authorize a request for borrowed funds.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a block diagram that shows a digital exchange system and its interaction with sponsors, community organizations or individuals, and participants, according to an embodiment of the present invention;

FIG. 2 is a block diagram illustrating various components of the digital exchange system, according to an embodiment of the invention;

FIG. 3 is a block diagram illustrating a digital media network constructed in accordance with an embodiment of the invention;

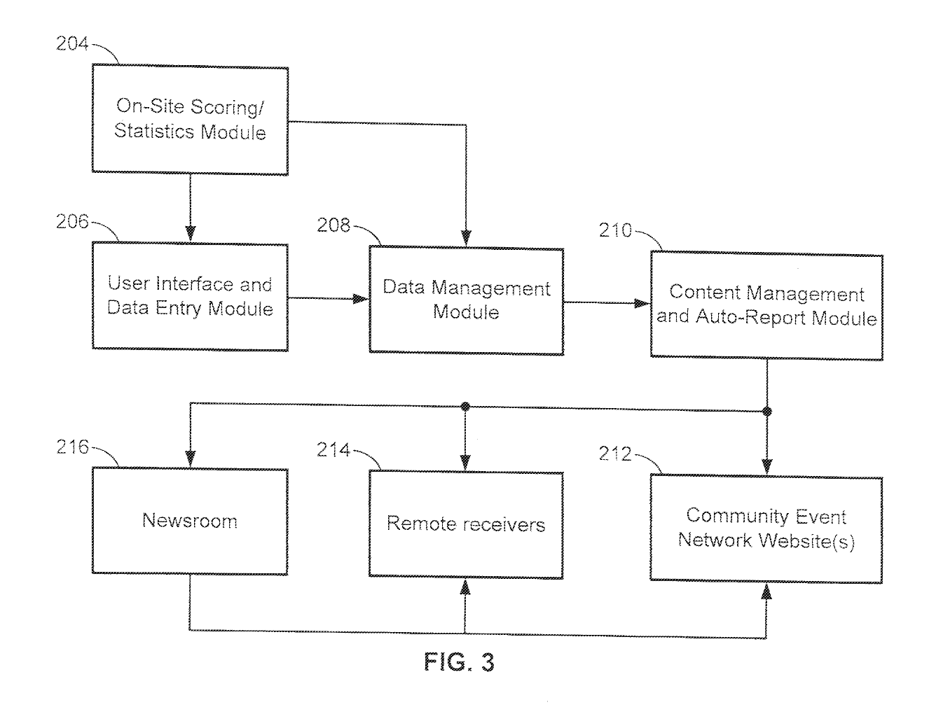

FIG. 4 is a flowchart illustrating an exemplary method of operating a digital exchange system, according to an embodiment of the invention;

FIG. 5 is a flowchart illustrating an exemplary method of operating a digital system using scannable codes, according to an embodiment of the invention;

FIG. 6 is a flowchart illustrating an exemplary method of operating a digital system, according to an alternate embodiment of the invention;

FIG. 7 is a schematic diagram showing the digital exchange system that includes a revolving sponsorship fund, in accordance with an embodiment of the invention.

FIG. 8 is a schematic diagram showing the relationship between organizations, sponsors, individuals, and digital exchange system, in accordance with an embodiment of the invention;

FIG. 9 is a flow diagram illustrating the creation of needs plans, according to an embodiment of the invention;

FIG. 10 is a flow diagram illustrating the creation of objectives plans, according to an embodiment of the invention;

FIG. 11 is a flow diagram illustrating the working of the advise system, according to an embodiment of the invention; and

FIG. 12 is a block diagram illustrating the interaction between the digital exchange network and community organizations, according to an embodiment of the invention.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

There is a need for an effective system to track the support and sponsorship with the purpose of directing resources to assist the sponsorship needs while assigning recognition within an integrated media network. Thus, as more and more organizations within a community create arrangements with businesses for continuous sponsorship, the need to provide a more automated and quantifiable method for resource allocation and recognition is apparent.

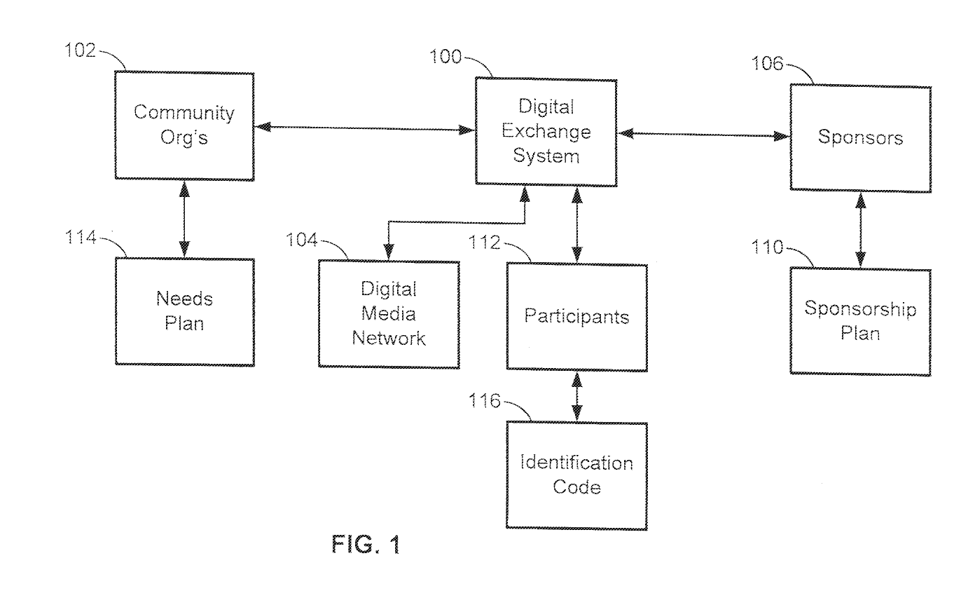

As shown in FIG. 1, embodiments of the present invention provide a digital exchange system 100 to track the support and sponsorship of community organizations 102 for the purpose of directing resources to assist the sponsorship needs while assigning recognition within an integrated digital media network 104. Further, embodiments of the invention permit community organizations 102 to create arrangements with sponsors 106 for continuous sponsorship, and to provide an automated and quantifiable method for resource allocation and recognition.

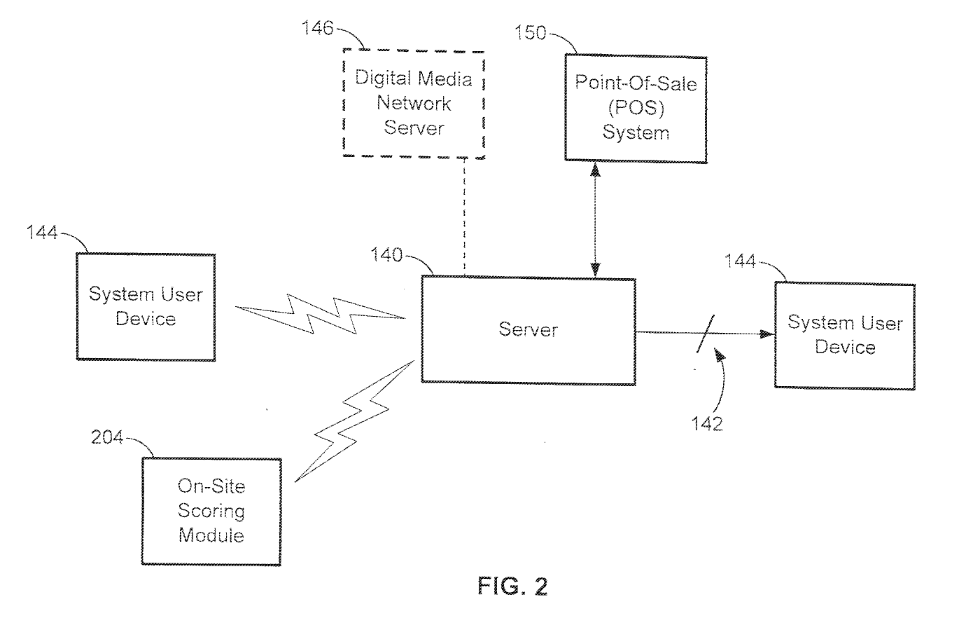

In at least one embodiment, a digital exchange system 100 for facilitating sponsorship of community organizations 102 includes a server 140 (see FIG. 2) connected to a network 142 (see FIG. 2), such as the internet, an intranet, cellular and/or Wi-Fi network, and programmed to provide for the electronic dissemination of community-based information, and programmed to provide a digital exchange system 100 to facilitate the sponsorship of community organizations 102 by sponsors 106 and participants 112.

FIG. 2 is a schematic block diagram that illustrates the server 140, network 142, and system user devices 144, according to an embodiment of the invention. System user devices 144 include, for example, personal computers connected to the internet or an intranet, mobile wireless devices such as smartphones or tablets. These system user devices 144 may be employed by members of the community organization 102, by the sponsor 106 and its employees, agents or affiliates, participants 112 in the sponsorship offer plan, also referred to as sponsorship plan 110, crowd-sourced reporters, etc. The server 140 may also be configured to wirelessly communicate with on-site scoring modules 204, which are discussed in more detail below. The primary elements of the digital media network 104 may reside on server 140, or optionally may reside on a digital media network server 146 (shown in phantom) in communication with server 140.

Embodiments of the present invention include a system and method which provide community organizations 102 and sponsors 106 an integrated, automated system that serves to match the needs of the organizations 102 (and the people therein) with the objectives of the sponsors 106 within a community and/or region.

In particular embodiments of the invention, community organizations 102 connect to the digital exchange network 100 in three primary ways:

1. A connection between the server 140 and system user from the community organization 102 that allows the system user to register and electronically submit a needs plan 114 that describes the needs of the community organization 102—and then based on that needs plan 114, receive automated reports generated by the system that assist the community organization 102 with visibility and sponsorship. Demographic, contact, and descriptive information may be provided by the community organization 102 as a part of a community organization profile. Details regarding desired sponsorship are provided as a part of the needs plan 114.

2. Use of the aforementioned connection that allows the system user to submit content about their activities and accomplishments for publishing on the digital media networks 104.

3. Connection to the digital exchange system 100 to:
Receive proposals from the sponsors 106;
Offer proposals to the sponsors 106; and
Participate in sponsorship plan 110 that results from purchases by the sponsorship plan participants 112.

The diagram of FIG. 1 also shows how sponsors 106 can interface with or connect to the network 142 (shown in FIG. 2) in three ways:

1. A sponsor 106 may join the digital exchange system 100 by electronically submitting registration information via the digital exchange system 100. In a particular embodiment, as an integral part of the sponsor registration, the sponsor 106 develops (and maintains thereafter) the sponsorship plan 110 and a sponsor objectives plan by filling out a template of information about the sponsor 106. For example, a restaurant may have an objective to increase business on a certain day of the week, and construct a sponsorship plan 110 that corresponds to that objective. Demographic, contact, and descriptive information may be provided by the sponsor 106 as a part of a sponsor profile.

2. Connection to the digital exchange system 100 to:
Receive proposals from community organizations 102;
Offer proposals to the community organizations 102;
Receive communications and recommendations from the digital exchange system 100 regarding various proposals;

3. Connection to the digital exchange system 100, which is attached to the digital media networks 104, and wherein the digital exchange system 100 may be configured to automatically position various types of promotions and/or advertisements that roll into one or more digital media networks 104.

In this way, the digital exchange system 100 facilitates sponsorship of community organizations. The digital exchange system server 140 is connected to a network and programmed to provide a system for the dissemination of community-based information, and programmed to provide a digital exchange to facilitate the sponsorship of community organizations by businesses and individuals. Embodiments of the present invention offer community organizations and sponsors an integrated, automated system that serves to match needs of organizations (and the people therein) with objectives of businesses within a community or region.

Community residents that are affiliated with organizations, either directly such as students, players or participants, or indirectly, such as alumni or supporters, also complete a profile template (and maintain thereafter).

An “Advise” section of the network contains an algorithm that monitors the on-going transactions through the system. The “Advise” system tracks, for example, the following and/or performs the following calculations: monthly purchase amounts input through the system—total from all businesses in a given community/region, breakdown by Business Category (categories e.g., as shown in the Digital Sponsor Platform), breakdown by Business Category averages, breakdown by Organization, i.e., purchase amounts attributed to each organization, and breakdown by Organization on a per user ID card (e.g., $100,000 of purchases were recorded in the exchange system for a specific organization and the organization has 500 ID cards, resulting therefore in an average for this organization of $200/ID card); for each participating business, number of registered users in each community organization or school that have made a purchase in the recent past (e.g., by month, over the last 6 months), comparing that to the total number of registered users in each community organization or school.

Participants 112, whether individuals or some other type of entity, may also be asked to register and to provide information which could be used to construct a participant profile. Part of the registration process may involve issuance of a unique identification code 116 for the participant.

In any community, there may be events which could affect sponsorship levels, or which could be used to affect sponsorship levels. To take advantage of these instances, community organizations 102 and sponsors 106 may disseminate information regarding the event and/or the sponsorship via the digital media network 104. In some cases, information may be efficiently disseminated by crowd-sourced reporting in which spectators or members of the general public provide facts, reporting, video, etc. to communicate the desired message. The digital media network 104 may be configured to electronically send out alerts soliciting crowd-sourced reporting, and further configured to process the information provided by such crowd-sourced reporting.

The digital exchange system 100 may also be configured to track one or more customer loyalty programs implemented by a particular sponsor 106, and allocate funds to the community organization 102 and awards to the participants 112 in accordance with the requirements of the customer loyalty program. Under some customer loyalty programs, customers may fall into any one of several program categories (e.g., platinum, gold, silver, etc.) which identify the status of the customer. The sponsor 106 may base certain allocations on a participant's status under the customer loyalty program. The digital exchange system 100 may be further configured to generate reports showing, for example, purchase history of participants 112, affiliations, interests, etc. In some embodiments, the digital exchange system 100 is configured to automatically notify participants 112 and sponsors 106 when the participant 112 is eligible for an award under the customer loyalty program. Additionally, it should be noted that, in a particular embodiment of the digital exchange system 100, sponsors 106 are able to offer sponsorship plans 110 allocating money to a community organization 102 that does not require participants 112 to register or to explicitly indicate any support for the community organization or acceptance of the sponsorship plan 110.

In certain embodiments, the on-site scoring/statistics module 204 receives data from crowd-sourced reporters. The module 204 can interface with or be an integral part of hardware devices such as portable electronic scoring devices, scoreboards, etc. to automatically obtain the data. The data can include information relating to a community event, a sporting event, an advertisement, a promotional event and the like. The module 204 interfaces with a user interface and data entry module 206 that sends the data to data management module 208. The user interface and data entry module 206 may also receive data from crowd-sourced reporters. Alternatively, module 204 directly sends data to data management module 208.

Data entered is stored in data management module 208, from which calculations are performed resulting in another level of analytics, such as sporting statistics, purchasing behavior, such as batting averages, earned run averages, team/individual standings, etc. Data management module 208 may include multiple data storage servers located at one or more selected locations. For example, the servers could be stored in a central location or distributed throughout the communities being served.

The content management and auto-report module 210 transforms the data into a format for viewing at community event network website(s) 212 and/or at remote receivers 214 throughout the community and/or region. The auto-report function automatically transforms parts of the data entered into print-ready verbiage for display on/in the various platforms. Print-ready verbiage means the data is in a grammatically correct format that is readable by an end user or ready for additional editing or review at newsroom 216. Newsroom 216 may be a newspaper newsroom, a television news station, news-based website, etc.

In a particular embodiment, the digital exchange system 100 contains an algorithm that monitors the on-going transactions through the system. The digital exchange system 100 tracks, among other things, the following and/or performs the following calculations: monthly purchase amounts input through the system—total from all sponsors in a given community/region, breakdown by business category (categories e.g., as shown in a digital sponsor network), breakdown by business category averages, breakdown by organization, i.e., purchase amounts attributed to each organization, and breakdown by organization on a per user ID card (e.g., $100,000 of purchases were recorded in the exchange system for a specific organization and the organization has 500 ID cards, resulting therefore in an average for this organization of $200/ID card); for each participating sponsor, number of registered users in each community organization or school that have made a purchase in the recent past (e.g., by month, over the last 6 months), comparing that to the total number of registered users in each community organization or school.

In the digital exchange system 100, sponsors 106 may enter the conditions for sponsorship or to enhance sponsorship, such as purchases made on a specific day or time of day. The sponsor 106 may also enter temporary programs or promotions during which time the sponsorship levels increase. The digital exchange system 100 may also be programmed to automatically send electronic notifications to selected participants 112 and community organizations 102.

Referring again to FIG. 2, it can be seen that an embodiment of the invention includes operating the digital exchange system 100 in connection with a point-of-sale (POS) system 150. In particular embodiments, the process is initiated when, for example, a community resident, in this case acting as a participant 112, enters, for example, a retail establishment of a sponsor 106 having a POS system 150 that is capable of linking participant sales to the digital exchange server 140. One way this may be accomplished is by assigning a particular function key or keys that make the association, such that a cashier may press the function key at the beginning, during or at the end of a transaction to indicate that the transaction is to be associated with the digital exchange system 100 (see FIG. 1). In this way, the digital exchange system 100 may be credited with a percentage of the proceeds from each of these sales or a fixed predetermined amount for each sale. Those credited proceeds are then allocated to the appropriate community organization 102 in accordance with the relevant sponsorship plan 110. For example, a participant 112 may be issued an identification (ID) card having the unique identification code 116 referred to above, thus indicating an affiliation with the digital exchange.

In this manner, the POS system 150 can assign and track all sales resulting from those particular sponsorships being initiated by the digital exchange, and provide in a single document, a spreadsheet in a predetermined format for example, the total sales volume for a given period that is associated with the digital exchange. This data may be provided to the operator of the digital exchange system 100 to facilitate the transfer of any funds due the digital exchange. In a particular embodiment, this data is transferred electronically between the POS system 150 of the sponsor 106 and the digital exchange system 100. Such data transfers may occur automatically at predetermined intervals (e.g., weekly or the first day of the month). In alternate embodiments, the data may be transferred electronically between the POS system 150 and the digital exchange system 100 by system operators or automatically.

To effect the subsequent transfer of funds from the digital exchange system 100 to its various community organizations 102, in at least one embodiment of the invention, the participant 112 accesses the digital exchange system 100, via the network using a PC or via a mobile application for example, to enter relevant data concerning any transactions that should be credited to a particular community organization 102. In certain embodiments of the invention, when the participant 112 accesses the digital exchange system 100, the participant 112 is given the option of allowing any proceeds from the participant's recent transaction(s) to flow to one or more previously selected community organizations 102. This may be a default allocation for any proceeds generated for the digital exchange system 100 by the participant 112. In a particular embodiment, this default allocation to one or more community organizations 102 is stored in the digital exchange system 100 until modified or deleted by the participant 112. The participant 112 also has the option to designate one or more other community organizations 102 to receive the proceeds from any transactions being entered into the digital exchange system 100. The proceeds can be divided among one or more community organizations 102 in any percentages specified by the participant 112.

The digital exchange system 100 can be further programmed to periodically (e.g., monthly, weekly, daily, etc.) generate reports regarding purchases made under each sponsorship plan 110 during the period, allocations to community organizations during the period, and invoices to sponsors 106 and/or community organizations for services provided by the digital exchange.

However, in alternate embodiments of the invention, when sponsors 106 without a POS system 150, the cashier and/or participant may use a networked personal computer or a mobile device such as a tablet, or smart phone, or business kiosk with the appropriate application software platform to enter any data for transactions which may be requested by the digital exchange system 100. Furthermore, the sponsor 106 may have a mobile electronic communications device for the entry of information to be transmitted to the digital exchange system 100. In particular embodiments, the mobile electronic communications device may run a mobile application configured to transfer information to the digital exchange system 100 in a specific format or sequence.

For example, if the participant has an ID card and unique identification code 116 associated with the digital exchange system 100, the cashier may scan and/or enter all of the necessary data into the mobile communications device at the time of the sale. Alternatively, data may be entered by the participant, at a designated business kiosk, and may include an ID card with an identification code 116 or some other identifying information, along with the details of the particular transaction with the sponsor 106. In these cases, data can be entered into the kiosk or mobile application in an online or offline fashion. If in offline mode, the data can be transferred electronically subsequently to the digital exchange system 100.

The digital exchange system 100 may be configured to automatically reconcile the data from the participant with that provided from the POS system 150 of the sponsor 106. In certain embodiments, any inconsistencies in the data from the sponsor 106 and participant 112 are flagged by the digital exchange system 100 so that the appropriate corrections can be made.

In an alternate embodiment of the invention, the sponsor 106 may obtain certain information from the participant 112 at the time of sale to allow the digital exchange system 100 to make the allocations without additional input from the participant 112. For example, the cashier may request a phone number or ID card number from the participant 112, and the POS system will record both the digital exchange system 100 and the participant identification code 116 associated with the transaction. Without any additional input from the participant 112, the digital exchange system 100 can use this information provided by the POS system 150 to properly allocate funds to community organizations 102 (and from there to needs, programs and participants 112 within the community organization 102) based on the default selections made by the participant 112.

In this embodiment, the participant 112 may still have the option of accessing the digital exchange system 100 to modify the default allocations, or specify new allocations, for particular transactions. For example, the participant 112 may specify that all proceeds from transactions with one sponsor 106 go to a first community organization 102, while all proceeds from transactions with a second sponsor 106 go to a second community organization 102. Another example, the participant 112 may specify that proceeds from transactions go to multiple community organizations 102, with specified percentage weights.

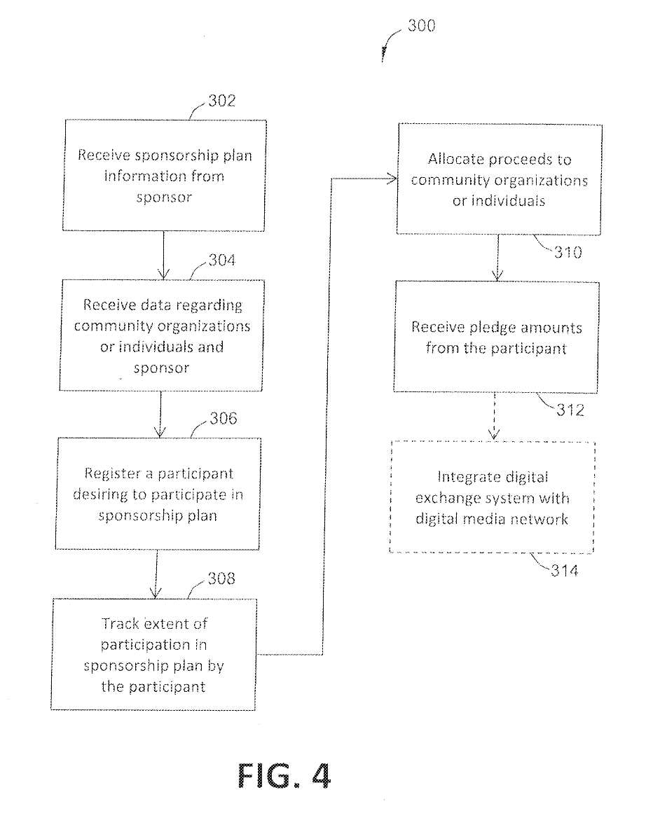

FIG. 4 is a flowchart illustrating an exemplary method of operating a digital exchange system 300. In an embodiment of the method shown in FIG. 4, the digital exchange system receives an electronic communication from the sponsor 302 with information regarding a sponsorship plan being offered by the sponsor. This information may include details on how participants can take advantage of the offer put forth by the sponsor, and how much the sponsor will contribute for purchases or other actions taken by the participant. The digital exchange also receives electronic communications from individuals, organizations, or sponsors 304 with specific profile information. This information may include personal information used to identify and communicate with the provider of the information. Information from the individual or organization may also include the amount of funding desired, the timing for obtaining the funding, the purpose for the funding, and how the funds will benefit the individual or organization and the community as a whole.

As explained above, in certain embodiments, participants in the digital exchange system will be asked to register and to provide information 306 which could be used to construct or complete a participant profile. Part of the registration process may involve issuance of a unique identification code for the participant. As also explained above, the digital exchange system tracks the level of participation in each sponsorship plan 308. This may include performing the calculations of monthly purchase amounts input through the system, breakdowns by business category, organization, sponsor, number of registered users, etc.

The method of FIG. 4 also requires the digital exchange system to automatically allocate the proceeds 310 from participation in the sponsorship plans to the appropriate individual or organization. The digital exchange also receives electronic communications from participants with projected pledge amounts 312. The projected pledge amounts may be based on a sampling of the sponsorship proposals available for the individual or community organization being supported by the participant.

Optionally, the method of the present invention may include integrating the digital exchange system with a digital media network 314 (shown in phantom) that contains digital media publications configured to provide electronic magazines, websites, and mobile applications. Participants are provided subscriptions to such digital media publications, or pre-subscriptions to potential digital media publications, where the subscriptions are linked to the digital exchange system. The method may also include requesting registration of individuals for participation in one or more sponsorship offer plans or for subscription to the digital media network. Alternatively, the method may include electronically sending information regarding sponsorship and media platform subscriptions, and summarizing results of the participants and comparing the results to those of an organization or subgroup and the goals of the organization and subgroup. Further still the method may include tracking activity in the digital exchange system, allocating media coverage points, earned each time a tracked activity is detected on the digital exchange system, and notifying the one or more organizations or individuals when a specified level of media coverage points are earned, making the one or more organizations or individuals aware that media coverage on the digital media network is available.

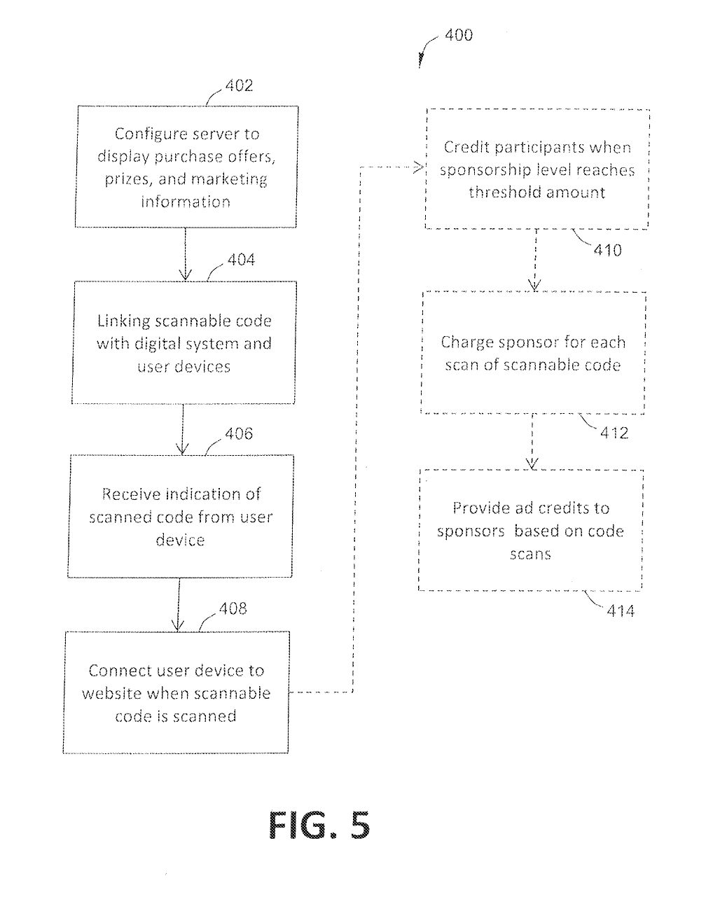

FIG. 5 is a flowchart illustrating an exemplary method of operating a digital system 400. In an embodiment of the method, shown in FIG. 5, calls for configuration of the digital exchange system server 402 to display purchase offers, prizes, and other marketing information. The method also requires linking a scannable code with the digital system and the electronic devices of system-users 404. These devices include, but are not limited to, smartphones, tablet computers, laptop computers, and notebook computers. The digital exchange system also receives an electronic communication 406 indicating when the scannable code has been scanned by the system user. Upon receiving this electronic communication, the digital exchange system connects the device which scanned the code to a website 408, which may contain a service directory. On this website, the system-user may be presented with a number of different offers from members listed in the service directory. The offers may include prizes, gift cards, discounted purchase deals, rebates of some kind, etc.

Optionally, the method of the present invention may include crediting a participant 410 (shown in phantom), with reward points for example, when the participant's sponsorship level reaches a threshold amount, or when the participant's scanning or sponsorship activities satisfy certain predetermined criteria. Another optional step of the method includes charging the sponsor a first fee 412 (shown in phantom) for each scan of the scannable code recorded by the digital exchange system when the scan does not result in a sale. A second fee, higher than the first fee, is charged to the sponsor when the scan does result in sale. However, when the number of scans recorded by the digital exchange system or the amount of fees charged to the sponsor reaches a threshold level, the sponsor may be provided with advertising credits 414 (shown in phantom), which the sponsor may use to place promotional advertisements in the various outlets of the digital media platform or within other media platforms.

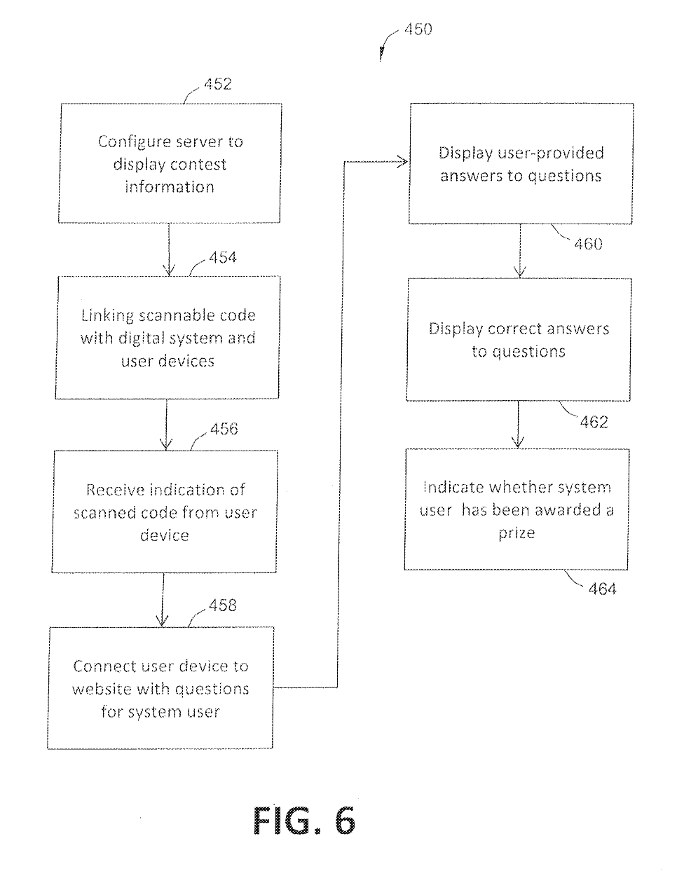

FIG. 6 is a flowchart illustrating an exemplary method of operating a digital system 450. The method includes the steps of providing a server connected to a communications network configured for two-way communications for system users. The method further includes configuring the server to display contest information 452, and linking scannable codes with the system and user devices 454. When one of the scannable codes is scanned, the server receives an indication 456 that the code has been scanned by a participant. The user device that scanned the scannable code is connected to a website 458 where information is presented and questions pertaining to that information displayed. The method further includes accepting and displaying, on a system-user device, user answers to the questions 460. The method also calls for subsequently displaying correct answers and comparing the correct answers with the user answers 462. Further still, the method includes indicating whether the user has received a prize or been entered into a drawing for a prize 464.

In addition to accepting electronically-submitted purchase offers from entities, and linking scannable codes to a system that serves as an entry point to a service directory, the digital exchange system 100 may also be configured to direct the system-user device of the system user to a website, web address, or URL that contains a service directory when one of the scannable codes is scanned by a system user. Further, the system may display offers for view, for system users, from entities in the service directory. Accepted and unaccepted viewed offers may be tracked by the digital system 100.

In particular embodiments of the invention, an entity providing the offer is charged, by the digital exchange system 100, a first amount for each offer view that does not result in a sale or other action by the user beyond a view, and is charged, by the digital system 100, a second amount, higher than the first amount, for each offer view that does result in a sale or other action by the user beyond a view

It is envisioned that, in some instances, sponsors will pay a specified amount for each scan of a scannable code, such as a matrix barcode or 2-D barcode. While the examples provided below typically refer to matrix barcodes, it is understood that the present invention is not limited to matrix barcodes, but may include scannable codes of different types, such as barcode and 3-D barcode. Businesses, or sponsors, may pay a specified first amount for a scan that does not result in a purchase, and may pay a specified second amount, (typically higher than the first amount) for a scan that does result in a purchase or other action taken by the user beyond the scan or view. These scan amounts will be tracked and once the amount reaches a predetermined level of amount, an advertising space is allotted to that business on a determined media platform. For example, the matrix barcodes may be placed in a daily print newspaper. Once the scan charges reach a certain level, the business will be notified that a certain amount of advertising inventory is available for that business to run/display an ad at no additional or lower charges.

In an embodiment of the invention, the digital exchange system 100 is configured to offer a sponsorship system for tuition assistance or contributions to college savings plans whereby the user participates in an educational question/answer process and a winner is selected from those that answer the set of one or more questions correctly. The user scans/reads a scannable code (for example, a matrix barcode being scanned by an app on a smart phone or computer tablet), via an electronic device capable of scanning the code, such as mobile electronic device (e.g., smartphone, tablet computer, etc.). The code can be displayed on any media platform, digital or otherwise, for example, within a newspaper, magazine, website, digital magazine, email, poster bulletin, window cling, newsletter, etc. After the code is scanned, the user's mobile device 144 is connected to a website where information is provided, for example, via a set of slides, or through a video, or through photos with captions, or through articles. This code can be a companion to other media content, like as a companion to an article in a newspaper, where the information in the code educational system is relevant to the article in the newspaper. The user is identified by the system via the unique user registration information, such as user ID, password, cell phone number, exchange/network ID number, etc. After the information is presented, the user answers a set of one or more questions. Depending on the answers, the user may be positioned for a drawing for a “prize”—such as an amount of money towards a college savings plan or tuition reimbursement.

In a particular embodiment of the invention, the matrix barcode targets specific individuals who participate in a sponsorship and/or digital network where purchase offers, prizes, and/or other marketing information are presented through a code that can be scanned/read, for example via a mobile device app (like a matrix barcode being scanned by an app on a smart phone or computer tablet). After scanning, the matrix barcode, the user device 144 (e.g., smartphone, laptop computer, notebook computer, tablet computer, etc.) is connected to a website where a business deal is presented to the user that is unique to that user.

The uniqueness of the deal is determined by an algorithm or set of algorithms within the digital exchange system 100, based on the activity of the user in the digital exchange system 100, and/or information input by the user into the digital exchange system 100. The user is identified by the digital exchange system 100 via the unique user registration information, such as user ID, password, cell phone number, exchange/network ID number, etc. The deal can be for a purchase that includes a discount, a purchase that includes a sponsorship for one or more schools or programs within schools, organizations or programs within organizations, a gift card or prize, a purchase that includes a raffle ticket for determined prizes, or a combination thereof. The scannable code can be displayed on any media platform, digital or otherwise, for example, within a newspaper, magazine, website, digital magazine, email, poster bulletin, newsletter, etc. In particular embodiments, Reward Points may be earned as the user uses the digital exchange system 100—in other words, a certain amount of points is earned for scanned offers that are declined, scanned offers that are accepted (meaning purchases are made or other action taken by the user beyond a scan and view), purchase activity in the digital network, etc.

In a particular embodiment of the invention, the matrix barcode system is used by a user, for example a business, to target specific customer sets based on organization/school memberships or participation, or based on sponsor exchange purchase activity. For example, businesses may target network users that are currently not their customers (where the definition of current customer is provided by the business—e.g., a cardholder/participant may be a current customer of a business if he/she has made a purchase in the last three months). Or businesses may target customers that will agree to make purchases at non-peak hours or seasons. Or alternatively, businesses may target participants of certain organizations, schools, or programs.

In a certain embodiment, a matrix barcode is placed in/on a media platform (e.g., a newspaper, magazine, digital magazine, website, etc.). The matrix barcode is scanned with a digital app that sends the user to a digital application platform where the user can then log in and begin the process of proposing a sponsorship event. The digital exchange system 100 may be configured such that the extent of exchange activity provides reward points for media coverage for schools, organizations, and programs. Therefore, the digital exchange system 100 tracks the activity in the digital media network 104 and “media coverage points” are earned each time activity such as purchases are made or matrix barcodes are scanned. Once a specified level of media coverage points are earned, an automatic notification is sent, electronically, to the relevant school, organization, team or program and the appropriate media coverage is established and executed. In some cases, “points” are earned for media coverage—where a certain amount of points will earn coverage of an event of the organization, school, or program within. Media coverage includes situations where some effort is made to cover an event and publish an article or video or photos of the event.

Embodiments of the invention include methods where a matrix barcode system on a given media platform (e.g., a newspaper, magazine, digital magazine, website, etc.) serves as a service directory that is attached to the digital media network 104 for a given region, that displays purchase deals for services/products that offer sponsorships for community organizations, schools and programs. The deals may include discounts, gift cards, reward points, or raffle tickets for an upcoming raffle event.

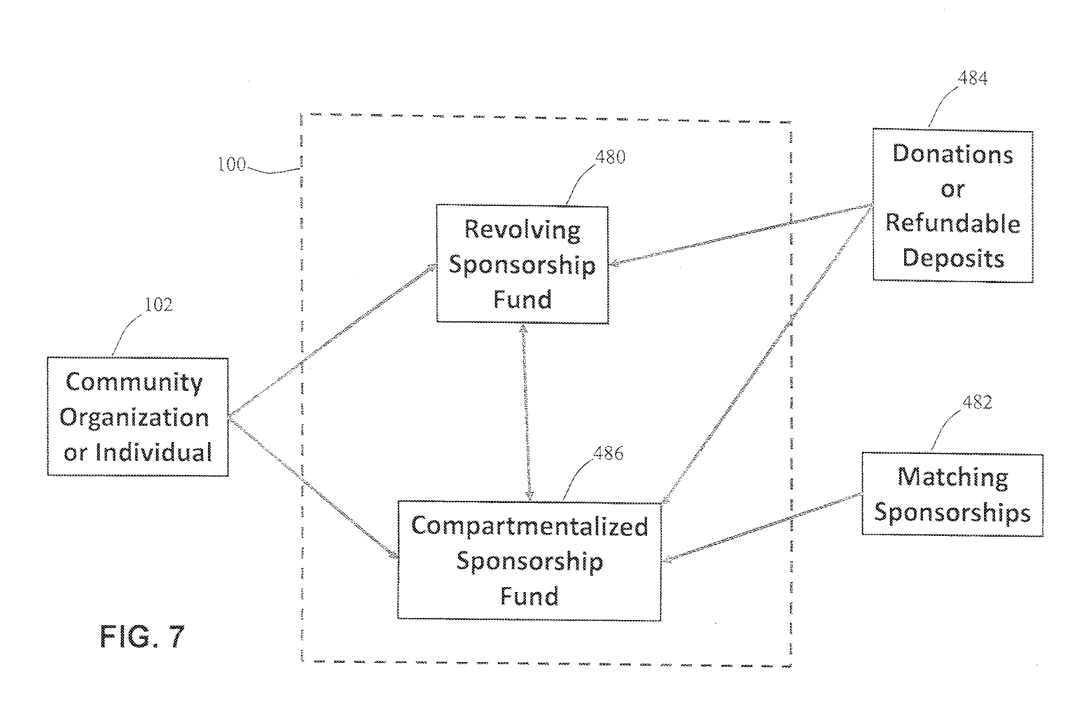

FIG. 7 is a schematic diagram showing the digital exchange system 100 that includes a revolving sponsorship fund 480, in accordance with an embodiment of the invention. In an embodiment of the invention, sponsors, such as corporations, businesses or other organizations, or even individuals, can electronically pledge (e.g., via the digital exchange system server 140—shown in FIG. 2) matching sponsorships 482—this matching sponsorship function being integrated with the digital exchange system 100 (see FIG. 7). In FIG. 7, the corporate and individual matching sponsorships 482 represent the system capability to electronically accept these matching sponsorship offers and to electronically account for the matching sponsorships 482 in a compartmentalized sponsorship fund 486. Therefore, once a matching sponsorship offer is pledged electronically in the system, and as individuals then make purchases in the digital sponsorship exchange system 100 (see FIG. 7), a matching sponsorship amount is also gained by the designated community organization or individual 102, as defined by the matching sponsorship offer (e.g., a $0.50 match for every sponsorship $1 earned). The digital exchange system 100 will electronically track the purchase activity and automatically account for the matching amounts, and allocate the appropriate funds to the designated community organization or individual 102.

The revolving sponsorship fund (RSF) 480 may be established to allow funds to be developed, consumed, and replenished by the community organizations or individuals 102 (see FIG. 7). The RSF 480 is an account where community organizations (or programs within the community organization) or individuals 102 can at times borrow an amount of money as needed—similar to a line of credit—from the RSF 480. The RSF 480 may be established electronically by one or more individuals or entities via refundable deposit or donation 484 and supplemented or replenished through purchase activity in the digital exchange system 100. Further, a pledge system may be utilized to establish the support group for the community organizations (or program within the community organization) or individuals 102 to borrow from the RSF 480—i.e., a group of people are registered in the digital exchange system 100, linked to a particular community organization or individual 102 within (e.g., a specific team in a sports organization or the drama club or a sports program within a school). As shown in FIG. 7, funds may flow between the RSF 480 and the compartmentalized sponsorship fund 486, when desired by the provider of a donation or refundable deposit 484 for example. Additionally, funds from the revolving sponsorship program 480 may be temporarily held in a compartmentalized sponsorship fund 486 for one of the one or more community organizations or individuals 102.

The registered users linked then pledge amounts of sponsorship through participation in the digital exchange system 100 (like $10/month for a year, etc.)—the pledge amounts are tallied—when the collective (aggregate) pledge amount reaches a predetermined sponsorship level over a specified period, the RSF funds (like a line of credit) become available for the community organization or individual 102 and the digital-exchange-system users then participate in the digital exchange system 100 with the objective of achieving the sponsorship amount as pledged. A refundable deposit may be provided as well as a donation 484. The refundable deposit 484, like a donation, can be directed at the RSF 480 or directly to a community organization or individual 102 through a compartmentalized sponsorship fund 486 (see FIG. 7). In certain embodiments, an interest rate is attached to the refundable deposit 484.

In certain embodiments, digital exchange system 100 facilitates the acceptance of sponsorship proposals that include a “pay-per-pledge” term—where an electronic exchange occurs between an individual, community organization, or program within a community organization, and the prospective sponsor before the terms of the sponsorship proposal have been fulfilled. The community organization participants collectively pledge to purchase an amount, thereby yielding an amount of sponsorship. The “pay-per-pledge” term in the proposal, once the proposal is accepted as part of the sponsorship plan, is one where the sponsor pays a portion, or all, of the pledged sponsorship amount up front before the purchases take place. In addition to enabling the pay-per-pledge feature, where participants collectively pledge to make purchases for a sponsorship amount from a sponsor, the digital exchange system 100 may also electronically notify the sponsor of the pledged amount, and electronically invoice the sponsor for some, or all, of the sponsorship amount resulting from pledged purchases.

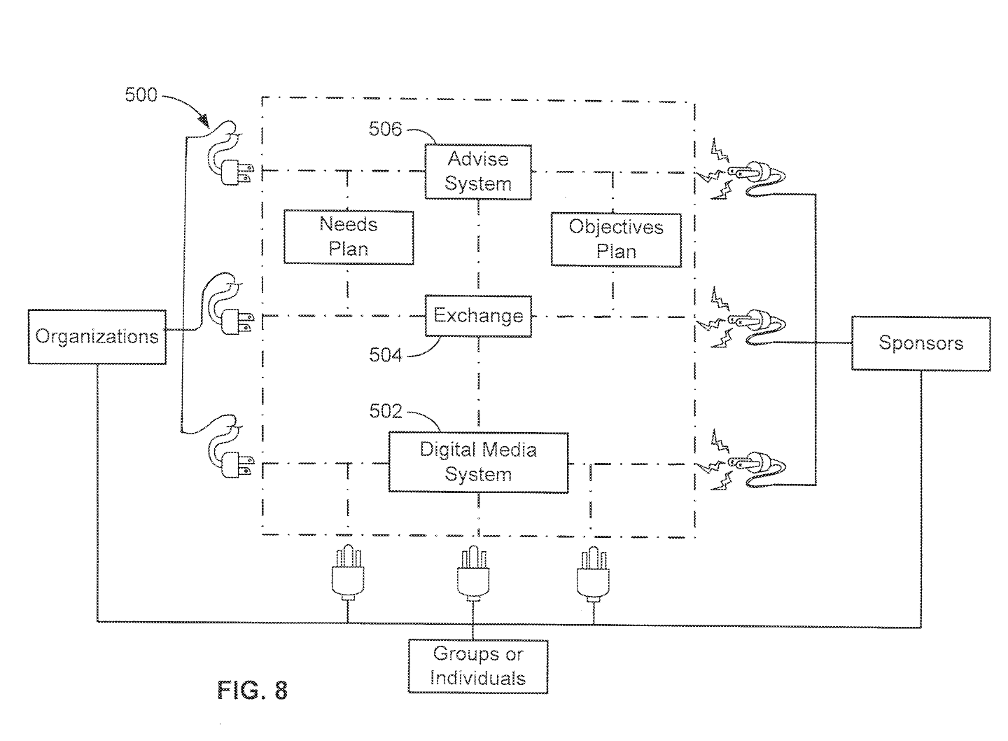

FIG. 8 is a schematic diagram showing the relationship between organizations, sponsors, individuals, and digital exchange system, in accordance with an embodiment of the invention. The diagram of FIG. 8 schematically illustrates a digital exchange network 500 which integrates a digital media center network 502, a sponsorship exchange network system 504, and a database, referred to as an advise system 506, which is configured to continuously electronically monitor purchasing behavior, and configured to maintain, within the database, statistical calculations of purchase behavior. The advise system 506 is further configured to use the statistical calculations to automatically generate a sponsorship proposal that matches an individual organization with an individual sponsor, based on particular funding needs of the individual organization and on particular objectives of the individual sponsor.

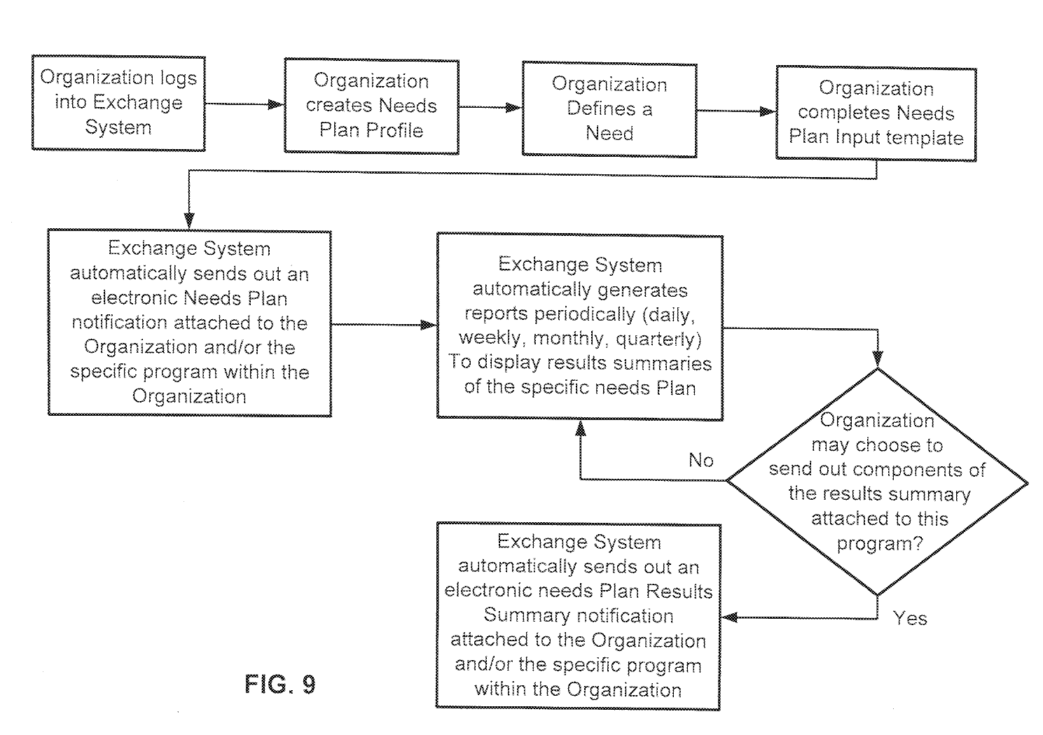

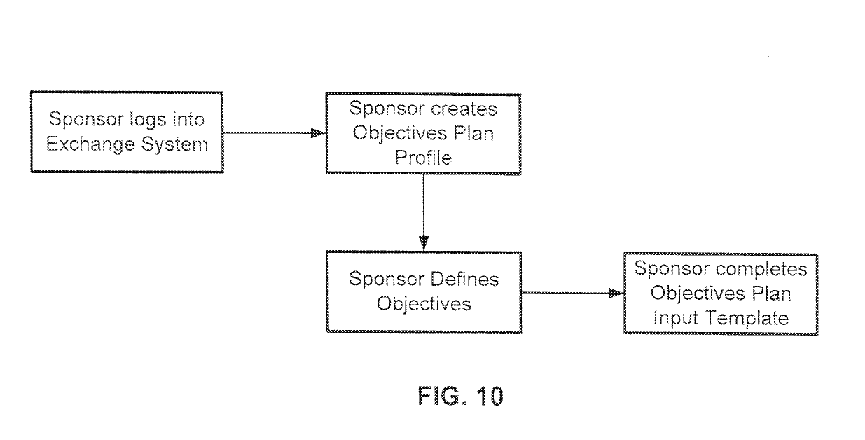

FIGS. 9 and 10 are flow diagrams that illustrate how needs plans and objectives plans are created on the advise system 506 (shown in FIG. 8), in accordance with embodiments of the invention. Organizations, such as community organizations, schools, charitable or nonprofit organizations, have funding needs which are captured in a needs plan. The needs plan includes one or more of the funding needs of an organization. The various funding needs listed in the needs plan may have different priorities, and different funding requirements, within the organization. Sponsors have objectives, for example for the improvement of the business, which are captured in an objectives plan. The objectives plan includes one or more of the objective of the sponsor. The various objectives listed in the objectives plan may have different priorities, and different funding levels, for the sponsor. In particular embodiments, the advise system 506 includes templates for the needs plans and objectives plans that can be completed by organizations and sponsors, respectively, prior to creation of the sponsorship proposal.

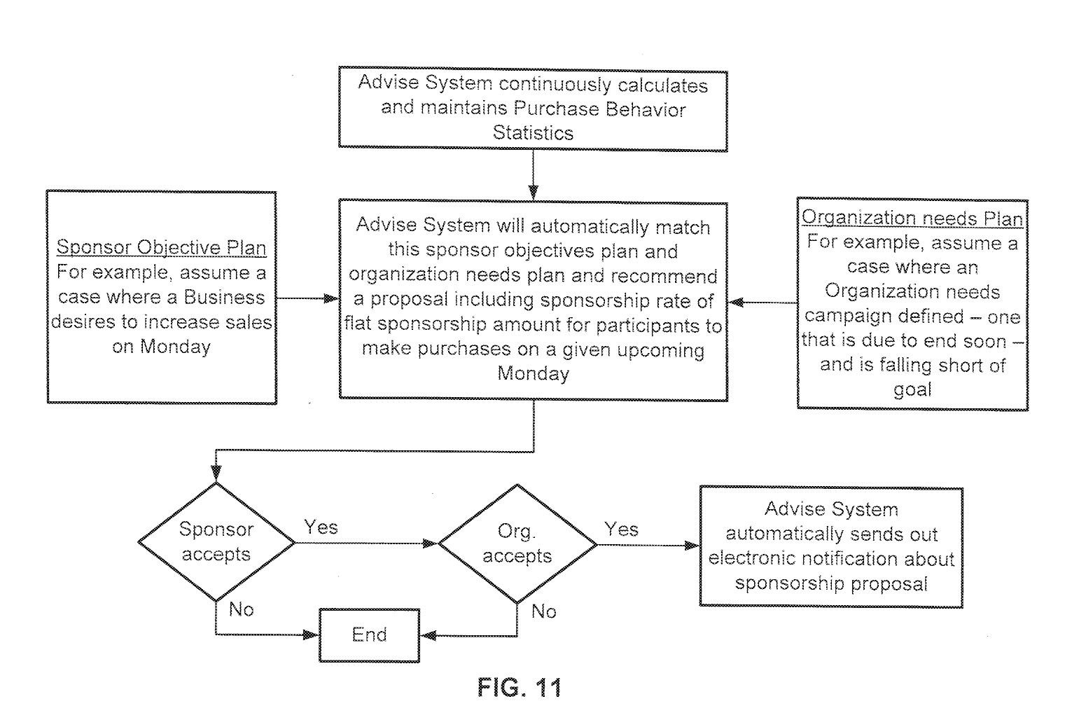

FIG. 11 is a flow diagram illustrating the working of the advise system, according to an embodiment of the invention. The advise system 506 (shown in FIG. 8) has a database and is configured to continuously electronically monitor purchasing behavior and to maintain, within the database, statistical calculations of purchase behavior. The advise system 506 is further configured to use the statistical calculations to automatically generate a sponsorship proposal that matches an individual organization with an individual sponsor, based on particular funding needs of the individual organization and on particular objectives of the individual sponsor.

In some embodiments, the advise system 506 is configured to automatically transmit a targeted promotion to one or more groups or individuals, wherein the targeted promotion is based on the sponsorship proposal. The targeted promotion may be transmitted to the one or more groups or individuals using electronic mail or electronic text messaging for mobile electronic devices. The advise system 506 may be further configured to monitor amounts pledged by the one or more groups or individuals in accordance with terms of the sponsorship proposal, and determine possible purchase behavior and places of business to make purchases that will allow the one or more groups or individuals to attain a pledged amount. In a more particular embodiment, the advise system 506 automatically notifies one or more groups or individuals of new promotions implemented in support of the sponsorship proposal, when the advise system 506 determines that the new promotion is of interest to the one or more groups or individuals.

In certain embodiments, the advise system 506 (shown in FIG. 8) automatically transmits the targeted promotion over the digital media center network 502 (shown in FIG. 8), wherein the targeted promotion is based on the sponsorship proposal. The advise system 506 may be further configured to evaluate the particular funding needs of the individual organization, where the funding needs are in the form of a needs plan. The needs plan can accommodate one or more needs having different priorities. The advise system 506 takes these priorities into account when generating the sponsorship proposal. The needs plan may include needs having different priorities and different funding requirements. In a particular embodiment, one or more groups or individuals participating in the sponsorship proposal are registered. Each registration is linked, within the advise system, each with at least one of the one or more needs in the needs plan.

In certain embodiments, the advise system 506 generates a sponsorship profile for each sponsor. The sponsorship profile includes all of the sponsorship proposals accepted by the respective sponsor along with a status thereof. The advise system 506 may be configured to distribute targeted promotions to the one or more groups or individuals participating in the sponsorship proposal by distributing a matrix barcode or 2-D barcode that can be scanned via a mobile electronic device. After the matrix barcode is scanned, the digital exchange 500 (in FIG. 8) then transfers a mobile electronic device user to an electronic site where the user can participate in transactions that support objectives of the sponsor. In some embodiments, the advise system 506 displays the matrix barcode on the digital media center network 502 (in FIG. 8), and credits the user for viewing the targeted promotion. In other embodiments, each time a matrix barcode is scanned, the advise system 506 credits the sponsor associated with the scan. In a further embodiment, the advise system 506 credits the user for submission of information for distribution on the digital media center network 502.

In a particular embodiment, the advise system 506 provides an electronic pledge feature devised to allow the sponsor to tailor a specific customized promotion for an individual or group within the sponsorship exchange system 504 (shown in FIG. 8). The electronic pledge feature may be further devised to allow sponsors to compete against one another via an electronic bidding pricing system for improving their respective customized promotions. The advise system 506 also evaluates the particular objectives of the individual sponsor, where the objectives being in the form of an objectives plan. The objectives plan can accommodate one or more objectives having different priorities, and the advise system 506 takes these priorities into account when generating the sponsorship proposal. The objectives plan may include objectives having different priorities and different funding levels. In a particular embodiment, the advise system 506 accepts a pledge from the one or more groups or individuals, and then links, within the advise system 506, the accepted pledge with at least one of the one or more objectives in the objectives plan.

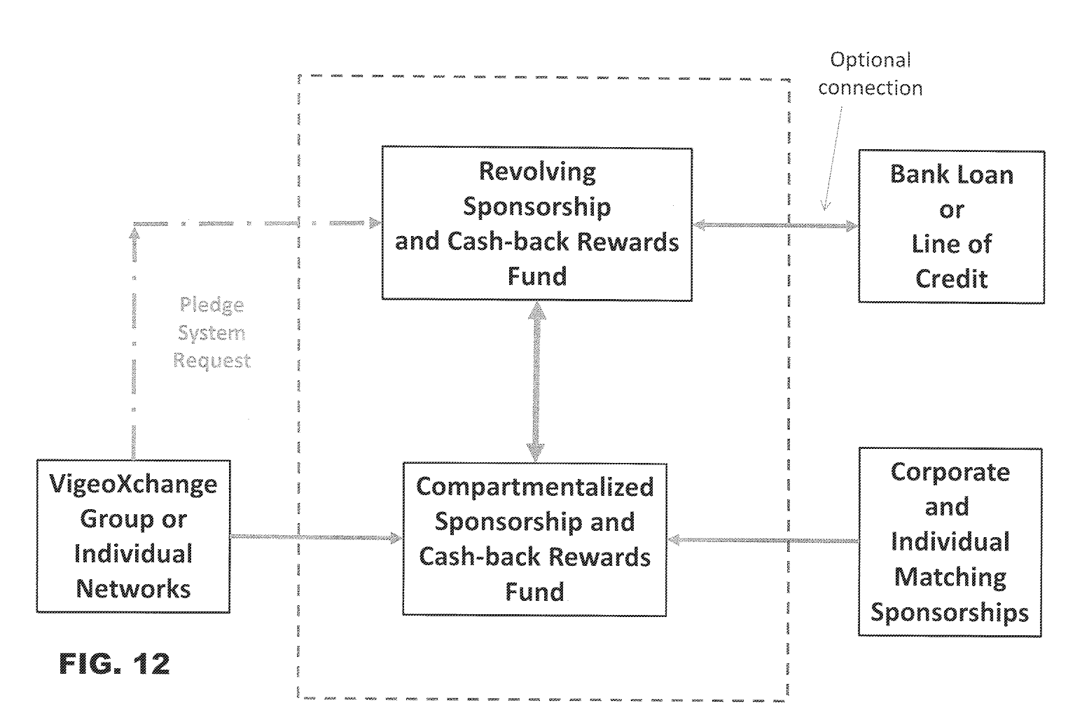

FIG. 12 is a block diagram illustrating the interaction between the digital exchange network and community organizations. In particular embodiments, a pledge system is used to establish the support group for the community organization or program within the organization to borrow from the revolving sponsorship fund (RSF). For example, a group of people and/or entities may be registered in the digital sponsorship exchange system, and linked to a particular community organization and/or program within that particular organization (e.g., a specific team in a sports organization or the drama club or a sports team within a school)—the registered users pledge amounts of sponsorship through participation in the digital sponsorship exchange system (e.g., $10/month for a year). The pledge amounts are tallied and when the collective (aggregate) pledge amounts for the entire group reaches an acceptable sponsorship pledge level, the RSF funds, similar to a line of credit, become available for the organization or program and the group. The transactions are facilitated by the digital sponsorship exchange system with the objective of achieving the sponsorship amount as pledged, plus any interest that has accrued (if applicable) until the borrowed amount is paid in full.

In some embodiments, a credit rating system is established. In one example, the credit rating system depends on variables such as (1) amount of registered users/cardholders activity in the digital sponsorship exchange system for those registered users linked to the organization or program within that are requesting funds from the RSF, (2) the pledge and participation history of the linked, registered users/cardholders—relative to both amount currently pledged in the system by each registered user and to how well each registered user has done historically with previous pledges, and (3) the pledge history of the organization or program relative to repayment of borrowed funds. An algorithm in the digital sponsorship exchange system calculates a credit rating based, in part, on the variables above. Credit rating scores directly impact the aggregate pledge amount necessary to be approved for the requested funds from the RSF. For example, an organization requests to borrow $10,000. A relatively high credit rating for a linked group of people may require a pledge amount totaling to $12,000 over a specified period of time. A relatively low credit rating for a linked group of people may require a pledge amount totaling to $14,000 over a specified period of time. The digital sponsorship exchange system may be configured to adjust interest rates based on the credit ratings.

The digital sponsorship exchange system may be constructed to track the actual sponsorship amounts produced and compares those actual amounts to the pledge amounts for each registered user and aggregately for the organization or program within the organization. Notifications may be electronically sent to linked, registered users and to administrators of organizations or programs—to notify each recipient of their individual performance of actual sponsorship relative to pledged amounts—and to also notify all recipients of the performance of the group collectively, actual sponsorship earned relative to the amount pledged. In certain embodiments, the system provides the means, such as an electronic interface, for an individual registered user or entity to electronically co-sign for the borrowed funds—meaning that the cosigner accepts responsibility for repayment of the borrowed funds, including any accrued interest if applicable.

Embodiments of the invention include a method where a “digital scratch-off app” (e.g., displayed on a user device at business locations throughout a community) displays a “scratch-off mystery offer, reward or prize.” When prompted to do so (e.g., clicking a button or touching a button on a touch-screen display), the app displays the removal of the “scratch-off covering” to reveal a result—can be a mystery offer, reward, gift card, or other prize. The “digital scratch-off app” may also be linked to a digital network (sponsorship and/or marketing network). The app displays a “scratch-off mystery offer, reward or prize.” For example, the user presents an ID code also linked to the digital network (sponsorship and/or marketing network)—the code is input into the app (manually or by scanning a barcode or other scannable code on an ID card—digital or not)—the app then displays the removal of the “scratch-off covering” to reveal a result—can be a mystery offer, reward, gift card, or other prize.

Referring again to FIG. 12, a block diagram illustrates the interaction between the digital exchange network and community organizations with respect to the administration of a cash-back rewards program. The cash-back rewards system may be combined with a digital exchange (sponsorship) network. In particular embodiments, the cash-back reward system provides a means for participants to receive cash-back rewards that can be used to pay individual fees, school tuition, etc. to participating organizations and schools. This rewards system may also be linked to the RSF. Individuals can borrow from the revolving fund to pay for fees, tuition, etc.—and then participate in the exchange network to pay down/back the borrowed funds, plus any interest incurred if applicable. The aforementioned pledge system may be used to establish the support group for the individual to borrow funds for the cash-back rewards system. A credit rating system may be established for the revolving fund and linked to the cash-back rewards system. Furthermore, a digital marketing or sponsorship system may be created which allows system users (entities, businesses, etc.) to position themselves into the pledge system where potential customers can pledge to do business with a given entity.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method of operating a digital exchange system, the method comprising:
providing a server connected to a communications network configured for two-way communications with system users;
configuring the server to display, on a system-user device, information on one or more community organizations or individuals and sponsorship needs thereof;
accepting, and displaying on the system-user device, electronically-submitted sponsorship offer plans from a sponsor for one or more community organizations or individuals;
accepting data regarding the one or more community organizations or individuals and the sponsor, the data submitted electronically by system users associated with the sponsor or the one or more community organizations or individuals;
registering a participant desiring to participate in one or more sponsorship offer plans, wherein said participation establishes an electronic link in the digital exchange system between the participant and the one or more community organizations or individuals;
providing an electronic revolving sponsorship fund, wherein the one or more community organizations or individuals can borrow funds from the revolving sponsorship fund;
electronically allocating the borrowed funds to the one or more community organizations or individuals, based on an amount requested by the one or more community organizations or individuals, and based on available funds in the revolving sponsorship fund;
electronically accepting and tracking pledged amounts, from digital exchange system users, to provide support for borrowing funds from the revolving sponsorship fund; and
providing an electronic credit rating system, which calculates a credit rating that is used to determine a required aggregate pledge amount necessary for approval and allocation of the requested amounts to one or more community organizations or individuals.

2. The method of claim 1, wherein the credit rating system calculates the credit rating based on an activity history in the digital exchange system of the registered participants associated with the organization requesting the funds.

3. The method of claim 1, wherein the credit rating system calculates the credit rating based on a pledge history of the registered participants associated with the organization requesting the funds.

4. The method of claim 1, wherein the credit rating system calculates the credit rating based on a pledge history of the community organization that is requesting the funds.

5. The method of claim 1, wherein the credit rating system provides the means for the registered participant or system user to electronically co-sign for the borrowed funds from the revolving sponsorship fund.

6. A method of operating a digital exchange system, the method comprising:
providing a server connected to a communications network configured for two-way communications for system users;
registering a participant or user desiring to participate in a community marketing network, and requiring the user to provide unique identification information;
configuring the server to display offers, prizes, or other marketing information on system user devices;
accepting electronically-submitted offers;
identifying the user via unique user registration information; and
linking a digital application function to the user, the digital application function being operable remotely via a unique location or identification, wherein the digital application function displays offers, rewards or prizes, which are unique to the user.

7. The method of claim 6, wherein configuring the server to display offers, prizes, or other marketing information comprises configuring the server to display offers, prizes, or other marketing information based on industry category.

8. The method of claim 6, further comprising:
configuring the server to display, on a system user device, information on one or more community organizations or individuals and sponsorship needs thereof;
accepting, and displaying on the system-user device, electronically-submitted sponsorship offer plans from a sponsor for one or more community organizations or individuals;
accepting data regarding the one or more community organizations or individuals and the sponsor, the data submitted electronically by system users associated with the sponsor or the one or more community organizations or individuals; and
registering a participant desiring to participate in one or more sponsorship offer plans, wherein said participation establishes an electronic link in the digital exchange system between the participant and the one or more community organizations or individuals.

9. The method of claim 6, wherein the digital application function is performed by a “digital scratch-off application”, which displays a digitally removable “scratch-off covering” which, when removed, reveals one or more of the offers, rewards or prizes; and
wherein the “digital scratch-off application” is linkable to a digital network and accessible to the participant or user via a coded input such that, upon receipt of the coded input, the scratch off covering is removed.

10. A method of operating a digital exchange system, the method comprising:
providing a server connected to a communications network configured for two-way communications with system users;
configuring the server to display, on a system-user device, information on one or more community organizations or individuals and sponsorship needs thereof;
accepting, and displaying on the system-user device, electronically-submitted sponsorship offer plans from a sponsor for one or more community organizations or individuals;
accepting data regarding the one or more community organizations or individuals and the sponsor, the data submitted electronically by system users associated with the sponsor or the one or more community organizations or individuals;
registering a participant desiring to participate in one or more sponsorship offer plans, wherein said participation establishes an electronic link in the digital exchange system between the participant and the one or more community organizations or individuals;
tracking an extent of participation in the sponsorship offer plan by the participant;
allocating proceeds to the one or more community organizations or individuals based on the extent of participation in the sponsorship offer plan by the participant; and
electronically allocating proceeds to a cash-back savings account for the participant.

11. The method of claim 10, further comprising allocating payment of fees to community organizations from the cash-back savings account of the participant.

12. The method of claim 11, further comprising providing an electronic revolving fund where participants can request to borrow funds to pay fees to community organizations.

13. The method of claim 10, further comprising configuring an electronic pledge system wherein participants can pledge to do business with sponsors for specified offers.

14. The method of claim 10, further comprising configuring an electronic pledge system to establish a support network for the participant.

15. The method of claim 14, further comprising providing a credit rating system that calculates a credit rating for the support network to determine a pledge amount required in order to authorize a request for borrowed funds.

16. The method of claim 10, further comprising providing an advise system having a database and configured to continuously electronically monitor purchasing behavior and to maintain, within the database, statistical calculations of purchase behavior;
wherein the advise system is further configured to use the statistical calculations to automatically generate a sponsorship proposal that matches an individual organization with an individual sponsor, based on particular funding needs of the individual organization and on particular objectives of the individual sponsor.

17. The method of claim 16, further comprising the step of configuring the advise system to:
monitor amounts pledged by one or more groups or individuals in accordance with terms of the sponsorship proposal;
determine possible purchase behavior and places of business to make purchases that will allow the one or more groups or individuals to attain a pledged amount; and
automatically notify the one or more groups or individuals of new promotions implemented in support of the sponsorship proposal, when the advise system determines that the new promotion is of interest to the one or more groups or individuals.

18. The method of claim 16, further comprising the step of configuring the advise system to:
automatically transmit a targeted promotion to one or more groups or individuals, wherein the targeted promotion is based on the sponsorship proposal, wherein the targeted promotion is transmitted to the one or more groups or individuals over a digital media network, or via electronic mail, or via electronic text message.

19. The method of claim 16, further comprising the step of configuring the advise system to generate a sponsorship profile for each sponsor, the sponsorship profile including all of the sponsorship proposals accepted by the respective sponsor along with a status thereof.

20. The method of claim 16, further comprising the step of configuring the advise system to provide an electronic pledge feature devised to allow the sponsor to tailor a specific customized promotion for an individual or group within the sponsorship exchange system, the electronic pledge feature being configured to allow sponsors to compete against one another via an electronic bidding pricing system for improving their respective customized promotions.
